(19) United States
(12) Patent Application Publication
(10) Pub. No.: US 2006/0228021 A1
(43) Pub. Date: Oct. 12, 2006

(54) Method and system for producing fabrics with a large number of colors

(76) Inventor: Marco Leoni, Lesmo MI (IT)

Correspondence Address: MCGLEW & TUTTLE, PC, P.O. BOX 9227, SCARBOROUGH STATION, SCARBOROUGH, NY, 10510-9227, US

(21) Appl. No.: 11/100,153

(22) Filed: Apr. 6, 2005

(51) Int. Cl. G06K 9/34

(52) U.S. Cl. 382/164

(57) ABSTRACT

A method for reproducing by means of weaving a maximum number M of loom colors, an image formed or deemed to be suitably representable by a number of colors greater than M, comprises the phases of defining zones in the image, each one of which is formed or deemed to be suitably representable by a maximum number of colors equal at most to M; breaking up the image into subimages corresponding to the defined zones; weaving all the subimages onto patches of fabric, choosing for each patch the subimages to be woven thereupon in such a way as not to have in total more than M colors for each patch; cutting out the subimages of the patches; joining together the different subimages to obtain the image that it is desired to reproduce. Also a system according to the method is disclosed.

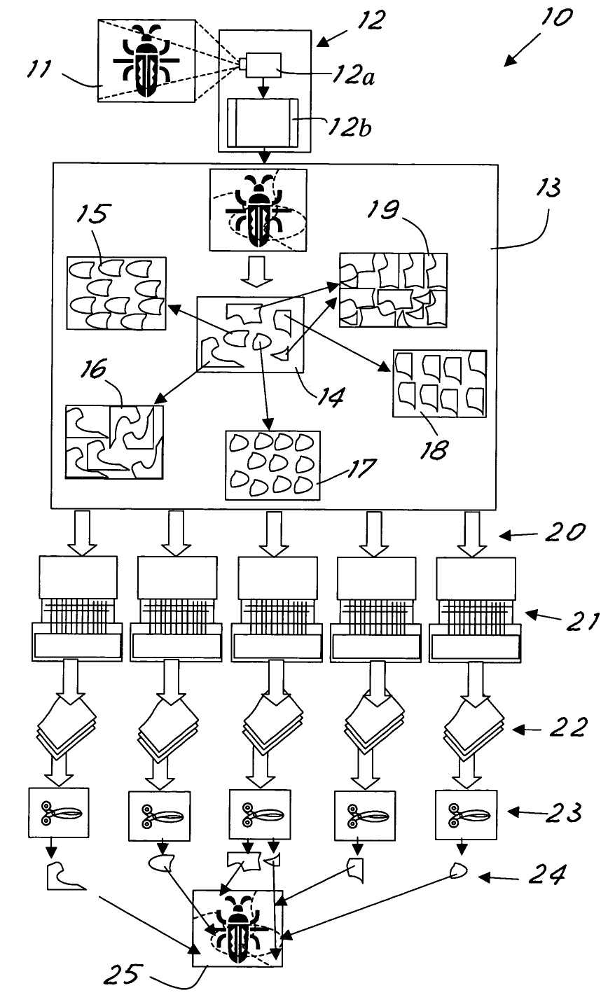

### BACKGROUND OF THE INVENTION

1. Field of the Invention

The present invention relates to a method and a system operating according to the method and a system according to the method for the production of fabrics with a large number of colors.

2. State of the Prior Art

It is well known that Jacquard weaving, specially the weaving dedicated to tapestries, bedspreads, shawls, carpets, etc has limitations regarding the number of weft colors and the type of usable warp.

In order to obtain the desired effects and therefore colors, combinations of warp and weft are made, that are properly called weaves. The number of colors of the threads simultaneously manageable by a loom is, however, limited and the effects obtained are almost always a compromise between the desire for faithful reproduction and the number of colors that can actually be used. Especially when it is desired to reproduce by means of weaving complex images (pictures, tapestries, photographs, etc, but also original subjects with a great number of shades of color) the quality of the result becomes unsatisfactory. An example is the reproduction of the subject of a picture using only an eight-color Jacquard looms.

The general object of the present invention is to obviate the aforementioned drawbacks by providing a method, and a system according to the method, that enable fabrics to be created that have a greater number of colors than those that are simultaneously manageable by the loom that is used.

### SUMMARY OF THE INVENTION

In view of this object it was decided to devise, according to the invention, a method for reproducing by means of weaving a maximum number M of loom colors, an image formed or deemed to be suitably representable by a number of colors greater than M, comprising the phases of defining zones in the image, each one of which is formed or deemed to be suitably representable by a maximum number of colors equal at most to M; breaking up the image into subimages corresponding to the defined zones; weaving all the subimages onto patches of fabric, choosing for each patch the subimages to be woven thereupon in such a way as not to have in total more than M colors for each patch; cutting out the subimages of the patches; joining together the different subimages to obtain the image that it is desired to reproduce.

Also according to the invention it was decided to devise a system for reproducing by means of weaving with a maximum number M of loom colors, an image formed or deemed to be suitably representable by a number of colors greater than M, comprises means for defining zones in the image, each one of which is formed or deemed to be suitably representable with a maximum number of colors equal at most to M and means for breaking up the image into subimages corresponding to the defined zones and means for producing commands to be supplied to the weaving looms for the production of fabric patches containing such subimages.

### BRIEF DESCRIPTION OF THE DRAWINGS

In order to make clearer the explanation of the innovative principles of the present invention and its advantages over the prior art clearer, a possible embodiment applying these principles will be disclosed below by way of example with the help of the sole enclosed schematic drawing.

### DETAILED DESCRIPTION OF THE INVENTION

The FIGURE shows a block diagram of a system, generally indicated by 10, applying the method according to claim of the invention for reproducing by means of weaving with a maximum number M of loom colors an image formed or deemed to be suitably representable by a number of colors greater than M. The wording “deemed to be suitably representable with a number of colors” means that at least that number of colors is deemed to be necessary to be able to reach the desired quality in the particular reproduction.

According to the method, once the image has been established that it is desired to reproduce (indicated by 11 in the FIGURE) zones are defined thereupon, each one of which is formed or deemed to be suitably representable with a maximum number of colors equal at most to M, i.e. equal at most to the number of colors that is usable on the looms that are intended to be used. The definition is based on the consideration that in practice the colors are generally present in an image distributed by zones, i.e. that any image, even if in its totality it is representable by an X number of colors, can be divided into parts that will have a number of colors much less than X. This occurs in a very high percentage of cases. The difference between the total number of colors and the number of colors that it is desired to use may possible affect the size of the defined zones.

For a rapid definition, the means used may comprise a computerized image acquisition and processing system 12. Such a system (for example equipped with a camera or scanner 12a and with a processing computer 12b) is in itself known and will not be disclosed or shown here any further.

Once the zones have been defined, the original image is broken down into subimages corresponding to the zones so that each subimage has a number of colors that is sufficiently low to be manageable by the selected looms. For the breaking down, breaking-down means 13 can be used (this also is creatable for example with a known computerized system) that breaks down the image into subimages 14 corresponding to the defined zones. For greater productive efficiency, images to be reproduced can also be created, each one of which is formed of the same subimage (as shown for example in 15-18) or also formed of several copies of different subimages (as shown in 19), if subimages exist the total number of colors of which is at most equal to the maximum number of colors manageable by the loom.

In substance, new images 15-19 are obtained that are reproducible with selected looms, as each of such new images has a number of colors that is at most the same as the number of colors simultaneously manageable by the loom selected to weave it.

At this point, with known means (easily imaginable by one skilled in the art) commands 20 are generated such as to supply new images 15-19 to the reproduction looms 21. Each new image can be produced by a separate loom, so as to have parallel production, or several images can be woven in sequence by the same loom, if necessarily changing the colors of the loom between one image and the next. A mixed solution can also be used in which several looms are used but some looms produce more than one image. In the case of parallel (or mixed) production looms with a low number of colors can be used for the images that allow it and looms with a greater number of colors (and which are therefore more expensive) can be used only for the images that require it.

With weaving, a plurality of fabric patches 22 is obtained, each one containing one or more subimages of the original image 11. The fabric patches 22 are then sent to in themselves known manual or automated cutting means 23 (advantageously with a laser cut to prevent excessive unraveling of the fabric) that enables a plurality of patches 24 to be obtained, each one reproducing with the appropriate number of colors a particular zone of the original image 11.

Finally, the pieces of the image are recomposed and joined together to obtain a patch of fabric 25 that reproduces the entire original image. The total number of colors will be much higher than the number of color woven by each loom. The joining can for example be obtained by (automatic or manual) sewing or gluing.

Again, according to the invention, on the back of the fabric patches that reproduce the subimages, a numbered grid can be advantageously reproduced for guiding the recomposition of the subimages in the original image. The grid may for example be a chequered grid with orthogonal lines that have to match by passing from a cut-out subimage to another that has to be brought up. The numbered grid means that the grid will also comprise any indication (not necessarily consisting of numbers) that clearly enables the different subimages to be recognized that make up the original image. A chart of the arrangement of the subimages will thus enable them to be rapidly brought up to form the original image during the joining operation. The numbered grid can be advantageously obtained during the weaving operation of the patches so as to ensure their correct positioning.

The edges of the zones can also be made to coincide with the edges shown in the separating image of image elements (e.g. the edge of a face in relation to the base). This enables the visibility of the joining zones of the patches to be reduced in the final product.

At this point it is clear how the objects of the inventions were reached.

The different zones of the fabric defined with criteria suitable for ensuring maximum homogeneity inside the zone enable the subrange of colors and effects of the final piece to be extended such as to multiply the available variations.

The final result, obtained after assembly, shows a greater variety of colors and effects, opening creative opportunities that were not imaginable before.

Naturally, the total creation that it is desired to obtain must be based on a very careful check of the zones in terms of colors and dimensions.

The possibility is provided for of putting numbers or other references on the back of the pieces to facilitate assembly.

It must be noted that the method according to the invention is completely different from any preceding technique. For example, according to the method used in the production of antique tapestries the zones of color were made one by one, but the tapestry was nevertheless produced in a single piece then sown into the spaces created by manual weaving. The invention also obviously differs from the well-known patchwork method. In fact, in our case, the pieces are designed a priori before assembly, size and shape are defined and created for a unique composition and not by the arbitrary will of the operator.

Neither can the invention be considered to be a puzzle because each piece contains similar colors and effects. The shape and size of the pieces are thus defined by a logic of color affinities and not as in the puzzles, by a pattern that is preset and independent of the figure to be composed.

Naturally, the above disclosure of a creation applying the innovative principles of the present invention is given merely by way of example of such innovative principles and must not therefore be taken to limit the scope claimed here.

What is claimed is:

1. Method for reproducing by means of weaving a maximum number M of loom colors an image formed or deemed to be suitably representable by a number of colors greater than M, comprising the phases of:
a) defining zones in the image, each one of which is formed or deemed to be suitably representable by a maximum number of colors equal at most to M;
b) breaking up the image into subimages corresponding to the defined zones;
c) weaving all the subimages onto patches of fabric, choosing for each patch the subimages to be woven thereupon in such a way as not to have in total more than M colors for each patch;
d) cutting out the subimages of the patches;
e) joining together the different subimages to obtain the image that it is desired to reproduce.

2. Method according to claim 1, wherein in the woven patches several copies of the same subimage are present so as to be able to obtain several copies of the image.

3. Method according to claim 1, wherein the phase of joining together the subimages is obtained by means of sewing.

4. Method according to claim 1, wherein the phase of cutting out the subimages from a patch is obtained by means of laser cut.

5. Method according to claim 1, wherein during the production of the subimages, on the back of the patches of fabric a number grid is reproduced for guiding to recomposition of the subimages in the original image.

6. Method according to claim 1, wherein edges of the zones are made to coincide at least partially with edges indicated in the original image as a separation of elements of the image.

7. System for reproduction by means of weaving with a maximum number M of loom colors an image formed or deemed to be suitably representable by a number of colors greater than M, comprises means for defining zones in the image, each one of which is formed or deemed to be suitably representable with a maximum number of colors equal at most to M and means for breaking up the image into subimages corresponding to the defined zones and means for producing commands to be supplied to the weaving looms for the production of fabric patches containing such subimages.

8. System according to claim 7, characterized in that the means for producing reproduction controls of the subimages selects for each loom subimages to be woven onto it in such a way as not have in total more than M colors for each patch woven by the loom.

9. System according to claim 7, characterized in that the identifying means comprises a computerized image acquisition and processing system.

10. System according to claim 7, characterized in that it comprises cutting means of the subimages of the patches.

11. System according to claim 8, characterized in that the cutting means is laser cutting means.

12. System according to claim 7, characterized in that it comprises joining means of the different subimages for forming the image that it is desired to reproduce.

13. System according to claim 12, characterized in that the joining means is sewing or gluing means.
